(19) United States
(12) Patent Application Publication
(10) Pub. No.: US 2016/0277964 A1
(43) Pub. Date: Sep. 22, 2016

(54) DEVICES AND METHODS FOR MULTIPLEXING AND DEMULTIPLEXING COMMON PUBLIC RADIO INTERFACE DATA STREAMS

(71) Applicant: TELEFONAKTIEBOLAGET L M ERICSSON (PUBL), Stockholm (SE)

(72) Inventors: Qing Xu, Saint-Laurent, Quebec (CA); Robert Brunner, Montreal, Quebec (CA); Stephane Lessard, Mirabel, Quebec (CA); Ulf Ekstedt, Saltsjöbaden (SE)

(21) Appl. No.: 14/410,381

(22) PCT Filed: Dec. 12, 2014
(86) PCT No.: PCT/IB2014/066869

§ 371 Date: Dec. 22, 2014

Related U.S. Application Data
(60) Provisional application No. 61/915,711, filed on Dec. 13, 2013.

(51) Int. Cl. H04W 28/06; H04W 4/06; H04L 12/18

(52) U.S. Cl. CPC H04W 28/065; H04L 12/1886; H04W 4/06; H04W 88/085

(57) ABSTRACT

Devices and methods are provided to allow the multiplexing and demultiplexing of Common Public Radio Interface (CPRI) data streams exchanged between a Radio Equipment Control (REC) and a plurality of Radio Equipment (RE) in a radio base station system. The device is generally configured to demultiplex a first downlink CPRI data stream received from the REC, generate a plurality of second downlink CPRI data streams from the demultiplexed first downlink CPRI data stream, multiplex a plurality of second uplink CPRI data streams received from the plurality of REs, and generate a first uplink CPRI data stream from the multiplexed plurality of second uplink CPRI data streams.

### CROSS-REFERENCE TO RELATED APPLICATIONS

The present application claims the benefits of priority of U.S. Provisional Patent Application No. 61/915,711, entitled “Photonics-Enabled CPRI Bit-Rate Adjustable Multiplexer and Demultiplexer”, and filed on Dec. 13, 2013, at the United States Patent and Trademark Office; the content of which is incorporated herein by reference.

### TECHNICAL FIELD

The present invention generally relates to methods and systems for data communications, and more particularly to Common Public Radio Interface (CPRI) data communications.

### BACKGROUND

The Common Public Radio Interface (CPRI) is a standard that defines a public specification for the internal interface between the radio equipment control (REC), also referred to as the baseband unit (BBU), and the radio equipment (RE), also referred to as the remote radio unit (RRU), comprised in radio base stations deployed in cellular networks.

By providing a common communication interface between RECs and REs, the CPRI specification enables product differentiation for radio base stations in that a REC manufactured by a first vendor can communicate, via a CPRI link, with a RE manufactured by a second vendor.

In addition, the common interface provided by the CPRI specification allows independent technology evolution for both RECs and REs.

However, despite the benefits of the CPRI, some challenges remain, particularly at the REC. For instance, a REC typically comprises a limited number of output CPRI ports to which REs can be directly connected. As network operators must deploy an increasing number of cells to accommodate the increasing mobile voice and data traffic, the number of REs that must be deployed must also increase.

Though the CPRI specification supports various network topologies, the typical topology is the star-like topology which often requires a large number of fanout interconnections from RECs to REs.

However, due to power, bandwidth and physical dimension limitations of the REC, when a network operator wants to deploy additional REs, the only generally available solution is to deploy additional RECs, with the implied additional costs.

Therefore, it would be desirable to provide devices and methods that obviate or mitigate the above described problems.

### SUMMARY

It is an object of the present invention to obviate or mitigate at least one disadvantage of the prior art.

The present invention generally provides a general purpose device and related methods for data communications, the device comprising common public radio interface (CPRI) user and control and management data multiplexing and demultiplexing functionalities.

In a first exemplary embodiment in accordance with the principles of the present invention, a multiplexer/demultiplexer device configured to multiplex and demultiplex CPRI data streams exchanged between a radio equipment controller (REC) and a plurality of radio equipment (REs) is provided. The device (hereafter the CPRI multiplexer) generally comprises a REC interface (e.g. a CPRI slave core) configured to receive a first downlink CPRI data stream from the REC and to transmit a first uplink CPRI data stream to the REC, and a plurality of RE interfaces (e.g. CPRI master cores) configured to each transmit a respective one of a plurality of second downlink CPRI data streams to a respective one of the plurality of REs and to each receive a respective one of a plurality of second uplink CPRI data streams from a respective one of the plurality of REs. The CPRI multiplexer also comprises circuitry (e.g. a CPRI switch and microprocessor) operatively connected to the REC interface and to the RE interfaces. The circuitry is generally configured, in the downlink direction (i.e. from the REC toward the REs) to demultiplex the first downlink CPRI data stream received from the REC, and to generate the plurality of second downlink CPRI data streams from the demultiplexed first downlink CPRI data stream, and in the uplink direction (i.e. from the REs toward the REC), to multiplex the plurality of second uplink CPRI data streams received from the plurality of REs, and to generate the first uplink CPRI data stream from the multiplexed plurality of second uplink CPRI data streams. The CPRI data streams exchanged between the REC and the REs generally comprise control words and data words.

In some embodiments, the first downlink CPRI data stream comprises first downlink control words and first downlink data words. In such embodiments, the circuitry may be configured to, for each of the plurality of second downlink CPRI data streams, generate second downlink control words as a function of the first control words and as a function of the respective RE to which the second downlink CPRI data stream will be transmitted, and to switch to the respective second downlink CPRI data stream the portion of the first downlink data words which are addressed to the respective RE.

In some embodiments, the plurality of second uplink CPRI data streams comprises second uplink control words and second uplink data words. In such embodiments, the circuitry may be configured to generate first uplink control words as a function of the second uplink control words of each of the plurality of the second uplink CPRI data streams, and to assemble the second uplink data words of each of the plurality of the second uplink CPRI data streams into first uplink data words.

In some embodiments, the first downlink CPRI data stream has a first bit rate, and each of the plurality of second downlink CPRI data streams has a second bit rate which may be equal to or smaller than the first bit rate. Additionally, the second bit rates may be all equal or may be different.

In some embodiments, the first downlink data words may comprise unicast data words, multicast data words, broadcast data words, or a combination thereof. In cases where the first downlink data words comprise multicast data words, the circuitry may be configured to replicate the multicast data words in at least two of the plurality of second downlink CPRI data streams such as to transmit the multicast data words to at least two REs connected to the device. Additionally or alternatively, in cases where the first downlink data words comprise broadcast data words, the circuitry may be configured to replicate the broadcast data words in all of the plurality of second downlink CPRI data streams such as to transmit the broadcast data words to all the REs connected to the device.

In some embodiments, the circuitry of the CPRI multiplexer may comprise a control word switching module (e.g. a control word switch) configured to generate, for each of the second downlink CPRI data streams, new control words as a function of the control words comprised in the first downlink CPRI data stream and as a function of the respective RE to which the second downlink CPRI data stream will be transmitted. The circuitry of the CPRI multiplexer may also comprise a data word switching module (e.g. IQ switch) configured to switch the data words comprised in the first downlink CPRI data stream and addressed to a respective RE to the respective second downlink CPRI data stream which will be transmitted to the respective RE.

In some embodiments, the CPRI multiplexer is configured to be pluggable in the CPRI port of a REC such as to interconnect the REC and RE units. In such embodiments, the pluggable device may be implemented such as to meet the SFP or SFP+ form factor requirements. Such SFP/SFP+ form factor is one of the most popular form factors used in Ethernet switches and radio base station systems.

In a second exemplary embodiment in accordance with the principles of the present invention, a method for multiplexing and demultiplexing CPRI data streams exchanged between a radio equipment controller (REC) and a plurality of radio equipment (REs) is provided. The method generally comprises a set of steps performed in the downlink direction (e.g. from the REC toward the REs) and another set of steps performed in the uplink direction (e.g. from the REs toward the REC). In the downlink direction, the method generally comprises demultiplexing a first downlink CPRI data stream received from the REC, generating a plurality of second downlink CPRI data streams from the demultiplexed first downlink CPRI data stream, and then transmitting each one of the second downlink CPRI data streams to the respective RE to which the respective second downlink CPRI data stream is addressed. In other words, in the downlink direction, the method generally entails transforming the single first downlink CPRI data stream into the plurality of second downlink CPRI data streams, and then transmitting each of these second downlink CPRI data streams to its destination RE. In the uplink direction, the method generally comprises multiplexing a plurality of second uplink CPRI data streams received from the plurality of REs, generating a first uplink CPRI data stream from the multiplexed plurality of second uplink CPRI data streams, and transmitting the first uplink CPRI data stream to the REC. Hence, in the uplink direction, the method generally entails transforming the multiple second uplink CPRI data streams received from all the REs into a single first uplink CPRI data stream, and then transmitting this single first uplink CPRI data stream to the REC. In such embodiments, the CPRI data streams exchanged between the REC and the REs generally comprise control words and data words.

In some embodiments, the first downlink CPRI data stream may comprise first downlink control words and first downlink data words. In such embodiments, the method may further comprise, for each of the plurality of second downlink CPRI data streams, generating second downlink control words as a function of the first control words and as a function of the respective RE to which the second downlink CPRI data stream will be transmitted, and switching the portion of the first downlink data words which are addressed to the respective RE.

In some embodiments, the plurality of second uplink CPRI data streams may comprise second uplink control words and second uplink data words. In such embodiments, the method may further comprise generating first uplink control words as a function of the second uplink control words of each of the plurality of the second uplink CPRI data streams, and assembling the second uplink data words of each of the plurality of the second uplink CPRI data streams into first uplink data words.

In some embodiments, the first downlink CPRI data stream has a first bit rate, and each of the plurality of second downlink CPRI data streams has a second bit rate which may be equal to or smaller than the first bit rate. Additionally, the second bit rates may be all equal or may be different.

In some embodiments, the first downlink data words may comprise unicast data words, multicast data words, broadcast data words, or a combination thereof. In cases where the first downlink data words comprise multicast data words, the method may further comprise replicating the multicast data words in at least two of the plurality of second downlink CPRI data streams such as to transmit the multicast data words to at least two connected REs. Additionally or alternatively, in cases where the first downlink data words comprise broadcast data words, the method may further comprise replicating the broadcast data words in all of the plurality of second downlink CPRI data streams such as to transmit the broadcast data words to all the connected REs.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 illustrates an exemplary communication network deployment.

FIG. 1A illustrates the basic system architecture of a radio base station of FIG. 1.

FIG. 2 illustrates basic system architecture and CPRI definition.

FIG. 3 illustrates an overview of the CPRI protocol stack.

FIG. 4 illustrates a basic frame structure for 614.4 Mbit/s CPRI line bit rate.

FIG. 5 illustrates a basic frame structure for 1228.8 Mbit/s CPRI line bit rate.

FIG. 6 illustrates a generic basic frame structure for 9830.4 Mbit/s CPRI line bit rate.

FIG. 7 illustrates a CPRI frame hierarchy and notation indices.

FIG. 8 illustrates the control word structure in a hyperframe.

FIG. 9 illustrates the control word disposition within a hyperframe.

FIG. 10 illustrate the definition of each control word within a hyperframe.

FIG. 11 illustrates an exemplary embodiment of a CPRI multiplexer that equally distributes a first high speed CPRI link into four second lower speed CPRI links according to the principles of the present invention.

FIG. 12 illustrates a flow chart of a method for multiplexing and demultiplexing CPRI data streams in accordance with the principles of the present invention.

FIG. 13 illustrates a flow chart of another method for multiplexing and demultiplexing CPRI data streams in accordance with the principles of the present invention.

FIG. 14 illustrates a block diagram of an exemplary embodiment of a CPRI multiplexer in accordance with the principles of the present invention.

FIG. 15 illustrates another block diagram of an exemplary embodiment of a CPRI multiplexer in accordance with the principles of the present invention.

FIG. 16 illustrates an exemplary embodiment of a 1:4 CPRI control words remapping in accordance with the principles of the present invention.

FIG. 17 illustrates an exemplary embodiment of a 1:4 CPRI data stream switching in accordance with the principles of the present invention.

FIG. 18 illustrates an exemplary embodiment of a CPRI multiplexer that unequally distributes a first high speed CPRI link into four second lower speed CPRI links in accordance with the principles of the present invention.

FIG. 19 illustrates an exemplary embodiment of a CPRI multiplexer that distributes a first high speed link comprising unicast, multicast and/or broadcast streams into four second lower speed CPRI links comprising unicast, multicast and/or broadcast in accordance with the principles of the present invention.

FIG. 20 illustrates an exemplary embodiment of service differentiation enabled by a CPRI multiplexer in accordance with the principles of the present invention.

FIG. 21 illustrates an exemplary embodiment of a CPRI multiplexer implemented as a hot pluggable SFP/SFP+ module.

### DETAILED DESCRIPTION

The present invention is generally directed to devices and methods for multiplexing and demultiplexing CPRI data streams between a radio equipment control (REC) and a plurality of radio equipment (REs).

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

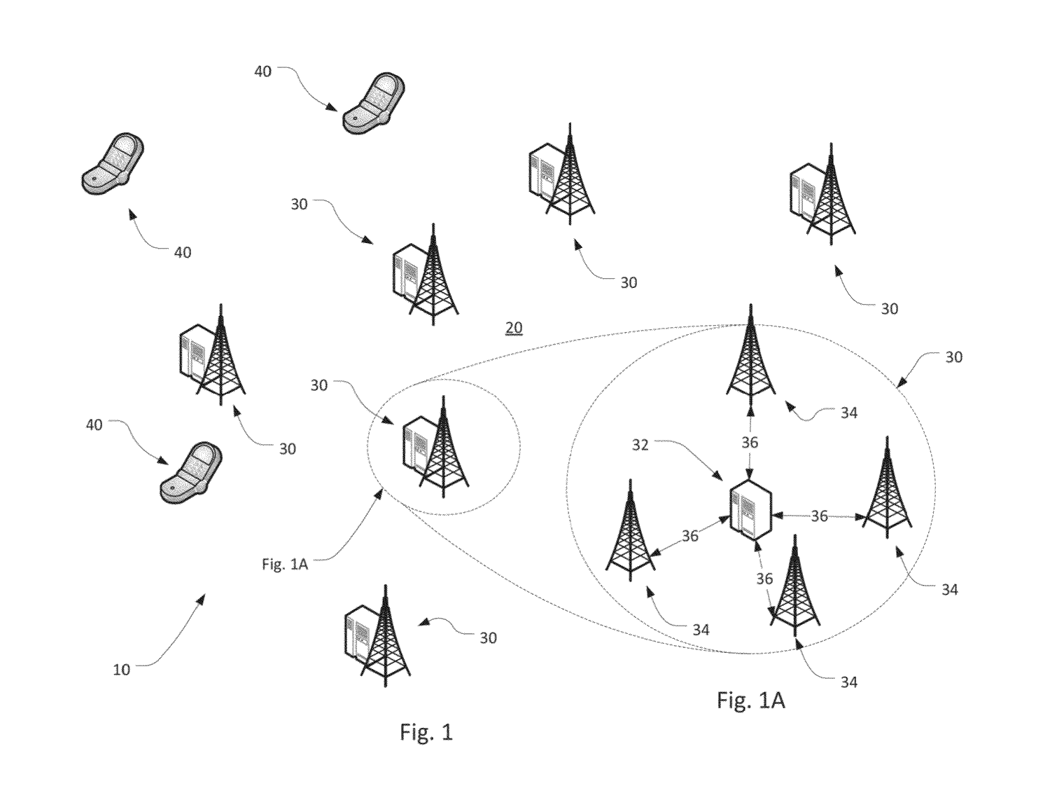

Referring first to FIG. 1, an exemplary cellular communication network 10 is illustrated. Communication network 10 comprises a radio access network (RAN) 20 comprising a plurality of radio base stations 30. The RAN 20 allows the mobile terminals 40 to access various networks (not shown) in manner known in the art. In the present exemplary network 10, wireless communication between the mobile terminals 40 and the radio base stations 30 is performed according to the long term evaluation (LTE) standard. However, the skilled addressee will appreciate that the communication network 10 could make use of a different wireless communication standard. In the communication network 10, the mobile terminals 40 (referred to as user equipment (UE) in the LTE standard), can communicate over an air interface with the radio base stations 30 (referred to as evolved Node B (eNB) in the LTE standard) in order to receive and transmit voice and data traffic.

Referring to FIG. 1A, in a cellular communication network such as communication network 10, a radio base stations, or eNB, generally comprises a radio equipment control (REC) 32 and one or more radio equipment (RE) 34. The REC 32 is generally configured to interface a core network (e.g. an evolved packet core (EPC), etc.) while the RE 34 is configured to provide the radio air interface (e.g. the radio access) to the UEs 40. In that sense, RECs 32 are typically installed in secured yet accessible locations, whereas the REs 34, which comprise the antennas, are usually deployed remotely from the RECs 32. In such eNBs 30, communications between a REC 32 and its associated REs 34 are performed over Common Public Radio Interface (CPRI) links 36 according to the CPRI specification (CPRI specification V5.0 incorporated herein by reference).

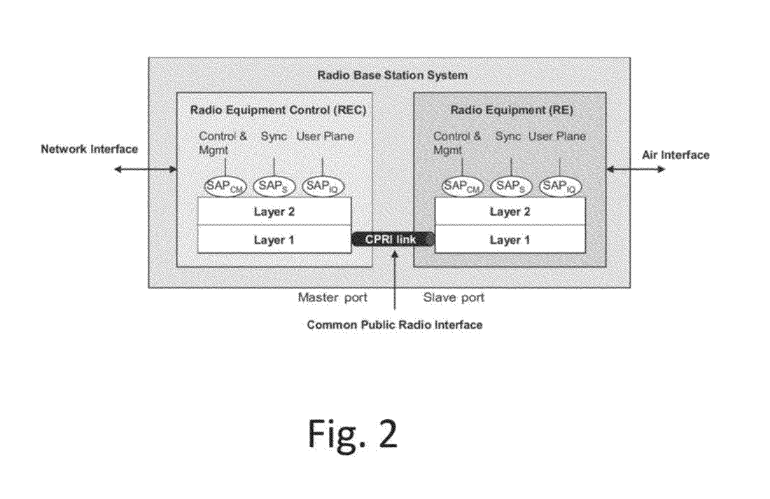

Referring now to FIG. 2, a block diagram of an exemplary radio base station system (e.g. eNB) 30 is illustrated. As shown in FIG. 2, the CPRI specification generally defines layer 1 and layer 2 protocols for the transfer of user plane data, control and management plane data as well as synchronization plane data over a CPRI link 36 between a REC 32 and RE 34 in a radio base station system 30.

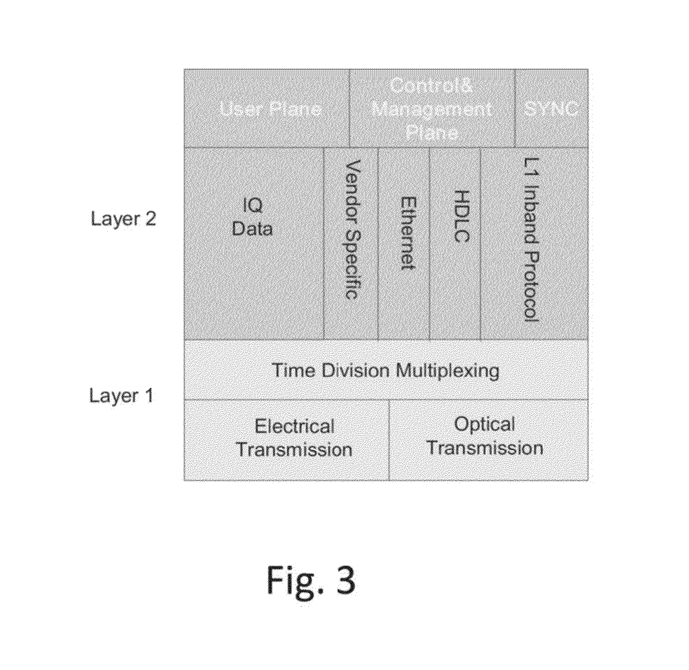

With additional reference to FIG. 3, layer 1 of the CPRI (i.e. the physical layer) supports both an electrical interface and an optical interface, while layer 2 (i.e. the data link layer) supports flexibility and scalability.

As communication between a REC 32 and a RE 34 is bidirectional, a CPRI link 36 generally comprises a bidirectional interface between two directly connected ports, typically between a REC 32 and a RE 34 (or possibly between two REs 34), using one transmission line per direction. In a CPRI link 36, data is said to be sent in the downlink direction when transmitted from a REC 32 to a RE 34 for a logical connection, and in the uplink direction when transmitted from RE 34 to REC 32 for a logical connection.

According to the CPRI specification, a CPRI link can support different line bit rates which can be selected from the following option list:
CPRI line bit rate option 1: 614.4 Mbit/s
CPRI line bit rate option 2: 1228.8 Mbit/s (2×614.4 Mbit/s)
CPRI line bit rate option 3: 2457.6 Mbit/s (4×614.4 Mbit/s)
CPRI line bit rate option 4: 3072.0 Mbit/s (5×614.4 Mbit/s)
CPRI line bit rate option 5: 4915.2 Mbit/s (8×614.4 Mbit/s)
CPRI line bit rate option 6: 6144.0 Mbit/s (10×614.4 Mbit/s)
CPRI line bit rate option 7: 9830.4 Mbit/s (16×614.4 Mbit/s)

As indicated above, user plane data, control and management plane data and synchronization plane data are transmitted over a CPRI link. The user plane data is generally transmitted in the form of in-phase and quadrature modulation (IQ) data.

According to the CPRI specification, one antenna-carrier, generally referred to as an AxC, is the amount of digital baseband user plane data, i.e. IQ data, necessary for either reception or transmission of only one carrier at one independent antenna element. A Ctrl_AxC designates one AxC specific control data stream. The number of available Ctrl_AxCs depends on the CPRI line bit rate. For instance, for CPRI line bit rate option 1 (i.e. 614.4 Mbps), a total of eight Ctrl_AxCs are available. Understandably, for higher line rates, this number increases proportionally. Still, the mapping of Ctrl_AxCs with number Ctrl_AxC# to AxCs as well as the actual content of the control data bytes are not defined in the CPRI specification but are vendor specific.

Over a CPRI link 36, data is exchanged in the form of CPRI frames. A CPRI frame comprises a hierarchy of frames.

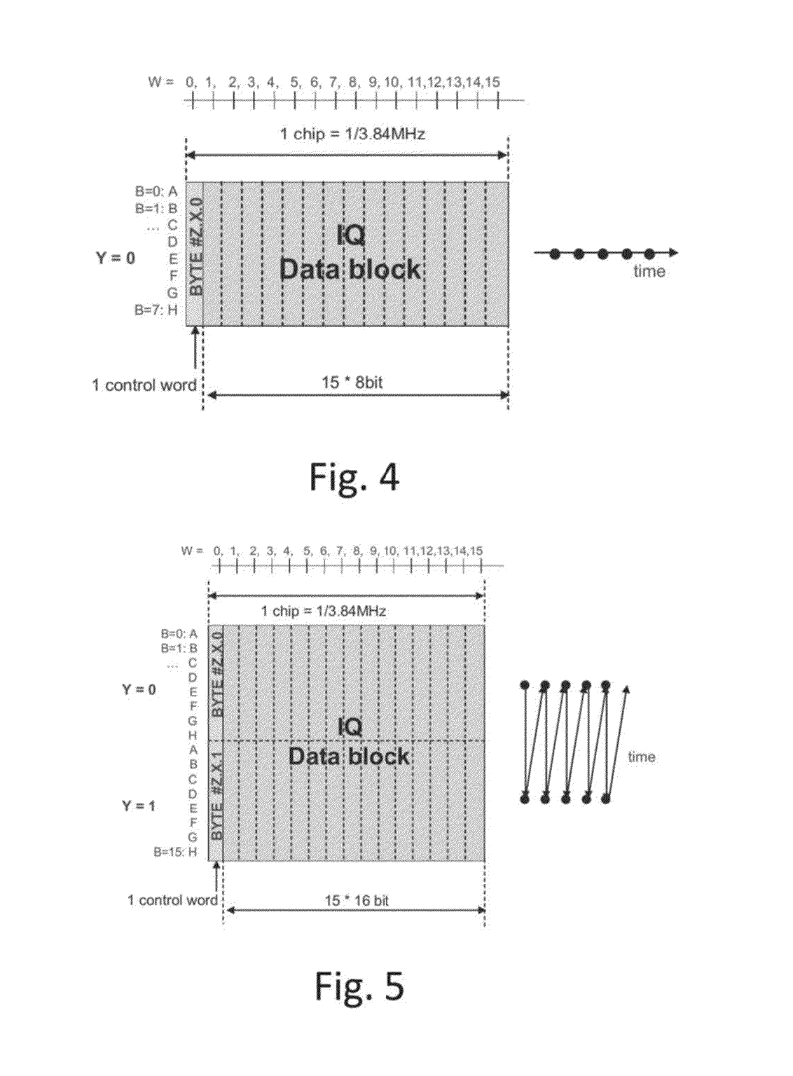

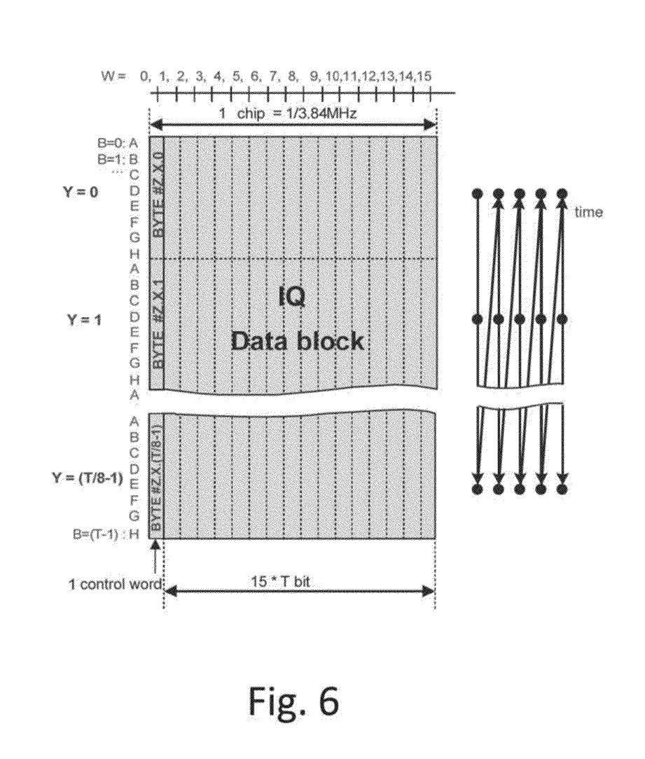

A shown in FIG. 4, a basic frame comprises 16 words with index W=0, 1 . . . 15. The word with the index W=0, i.e. 1/16 of the basic frame, is a control word. The remaining 15 words are data words which used for IQ data. The length T in bit of the word depends on the CPRI link line bit rate. The faster the line bit rate, the longer the length T. For instance, in FIG. 4, when the CPRI link used the line bit rate of option 1 (i.e. 614.4 Mbit/s), the length T is 8 bits. In FIG. 5, with the CPRI link line bit rate of option 2 (i.e. 1228.8 Mbit/s), the length T is 16 bits. FIG. 6 illustrates the generic length of the words as a function of the line bit rate.

Each bit within a word is addressed with the index B, where B=0 is the lowest significant bit (LSB) and B=T−1 is the most significant bit (MSB). Each byte within a word is addressed with the index Y, where B=0 is the LSB of Y=0, B=7 is the MSB of Y=0, B=8 is the LSB of Y=1, etc.

Next, a hyperframe comprises 256 basic frames, which can be addressed by the basic frame number X=0, 1 . . . 255.

Finally, a CPRI frame comprises 150 hyperframes which can be addressed by the hyperframe number Z=0, 1 . . . 149.

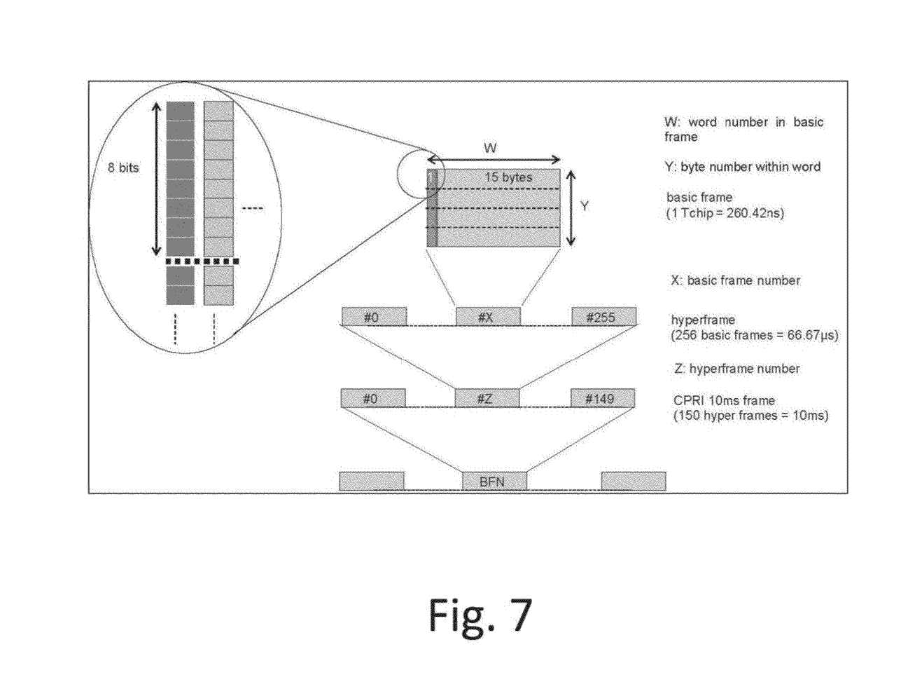

The overall hierarchy of basic frames, hyperframes, and CPRI frame is illustrated in FIG. 7.

According to the CPRI specification, the length of a basic frame is the duration of 1 chip, that is 1 T_{C}=1/f_{C}=1/3.84 MHz=260.416667 ns. Hence, the length of a CPRI frame is 10 ms.

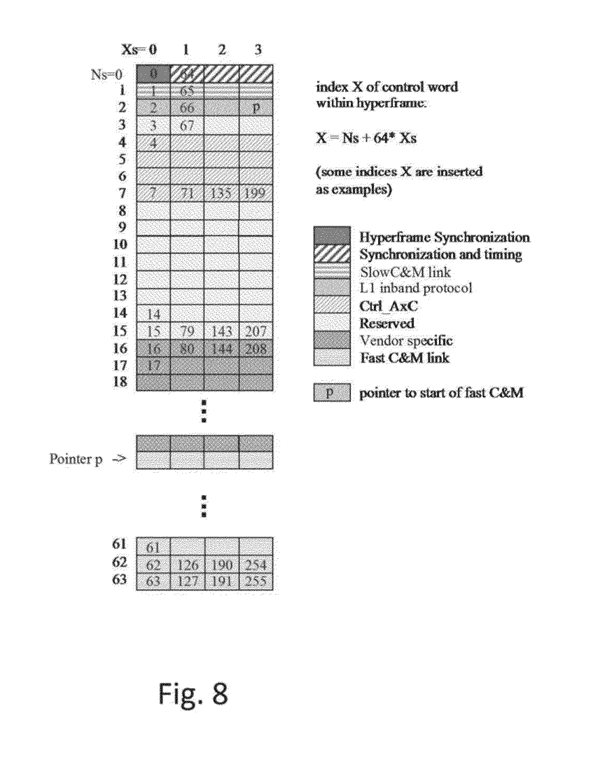

Since each hyperframe comprises 256 basic frames, and since each basic frame comprises 1 control word, each hyperframe comprises a total of 256 control words. In each hyperframe, a control word will carry different information depending on its position within the hyperframe. According to the CPRI specification, these 256 control words are organized into 64 sub-channels of 4 control words each. Hence, for each hyperframe, one sub-channel contains 4 control words. Referring now to FIGS. 8, 9 and 10, the structure of the control word sub-channels and the content of the control words in these various sub-channels are illustrated. The 64 sub-channels can be addressed by the sub-channel number Nₛ=0, 1 . . . 63 while the 4 words within each sub-channel can be addressed by the control word within sub-channel number Xₛ=0, 1 . . . 3.

Broadly, the 64 control word sub-channels comprise 8 types of information:
1—Hyperframe synchronization information;
2—Synchronization and timing information;
3—Slow control and management information;
4—Layer 1 inband protocol;
5—Ctrl_AxC information;
6—Reserved information;
7—Vendor specification information;
8—Fast control and management information.

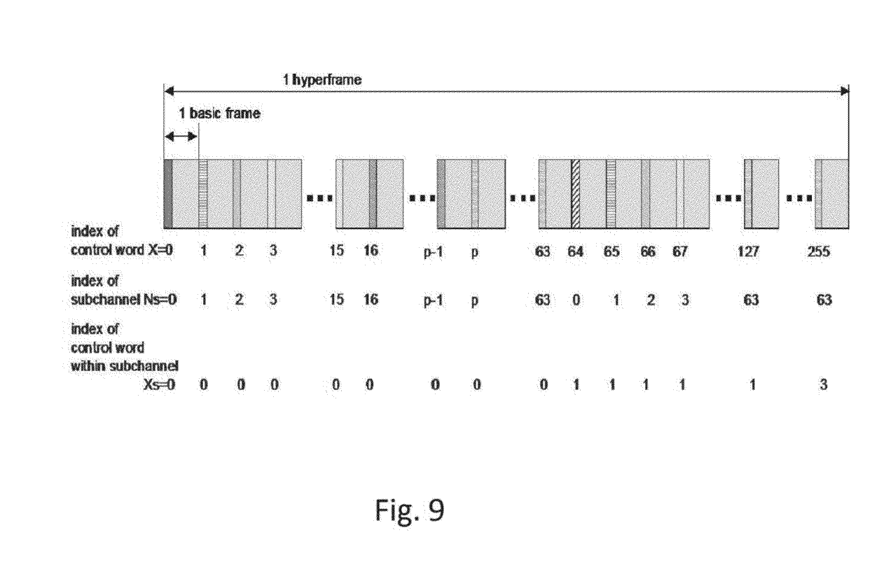

The disposition of the control words within a hyperframe is illustrated in FIG. 9.

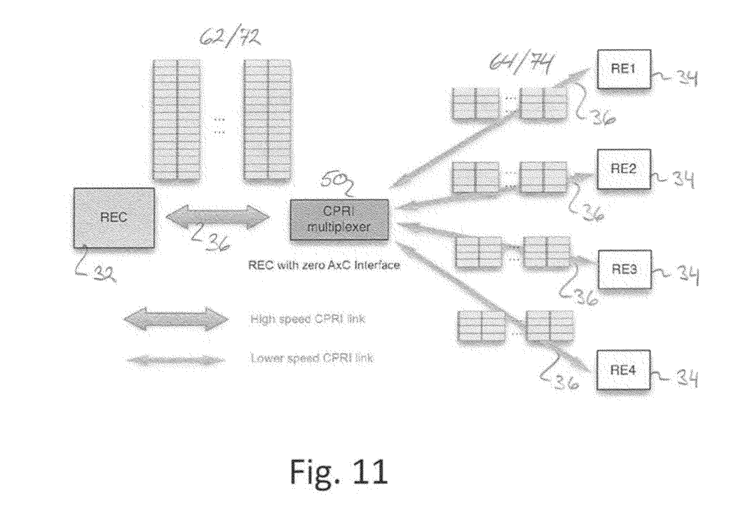

Referring now to FIG. 11, a high-level embodiment of a CPRI multiplexer device 50 in accordance with the principles of the present invention is shown schematically. The CPRI multiplexer 50 is generally configured to be located between a REC 32 and a plurality of REs 34 such as to communicate with the REC 32 over a first CPRI link 36, and to communicate with the REs 34 over second CPRI links 36.

As illustrated in FIG. 11, in the downlink direction, that is from the REC 32 toward the REs 34, the CPRI multiplexer 50 is generally configured to demultiplex a first CPRI downlink data stream 62 received from the REC 32 according to a first line bit rate into a plurality of second CPRI downlink data streams 64 which will be transmitted to respective REs 34 according to a second, and typically slower, line bit rate.

In the uplink direction, that is from the REs 34 toward the REC 32, the CPRI multiplexer 50 is generally configured to multiplex a plurality of second CPRI uplink data streams 74 received from the respective REs 34 according to the second line bit rate into a single first CPRI uplink data stream 72 which will be transmitted to the REC 32 according to the first line bit rate.

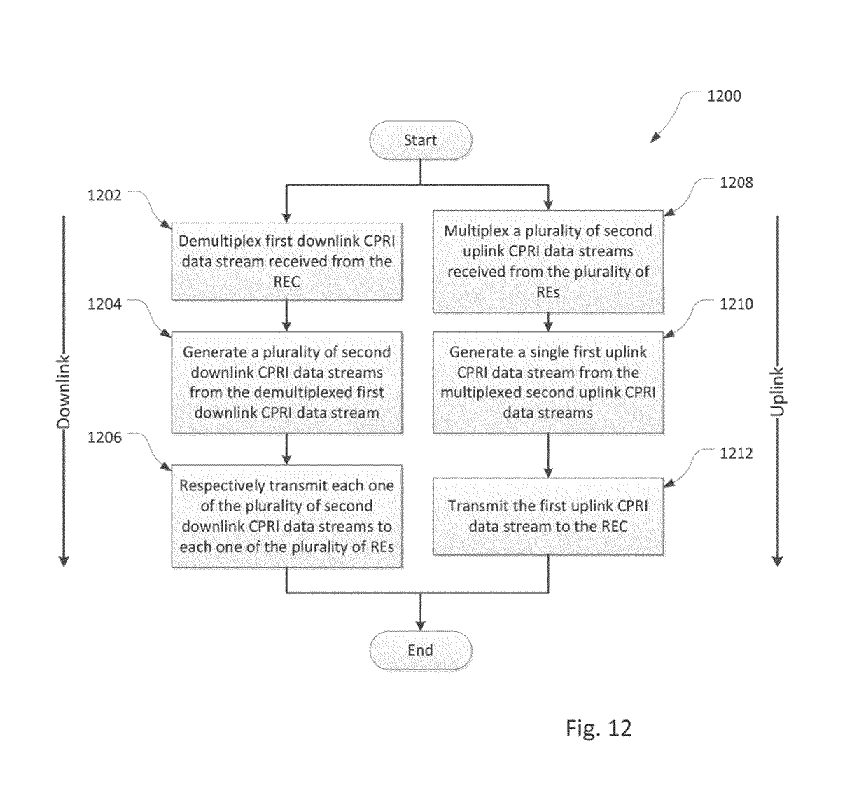

An embodiment of a method in accordance with the present invention as implemented by the CPRI multiplexer 50 can be further illustrated by the flow chart 1200 depicted in FIG. 12.

In the downlink direction, the CPRI multiplexer 50 generally demultiplexes a first downlink CPRI data stream (e.g. downlink stream 62) received from the REC 32 (step 1202). Then, from the demultiplexed first downlink CPRI data stream, the CPRI multiplexer 50 generates a plurality of second downlink CPRI data streams (e.g. downlink streams 64), one for each RE 34 (step 1204). Finally, the CPRI multiplexer 50 transmits each one of the plurality of second downlink CPRI data streams (e.g. downlink streams 64) to its respective RE 34 (step 1206).

In the uplink direction, the CPRI multiplexer 50 generally multiplexes a plurality of second uplink CPRI data streams (e.g. uplink streams 74) respectively received from the plurality of REs 34 (step 1208). Then, the CPRI multiplexer 50 generates a single first uplink CPRI data stream (e.g. uplink stream 72) from the multiplexed second uplink CPRI data streams (step 1210). Finally, the CPRI multiplexer 50 transmits the single first uplink CPRI data stream (e.g. uplink stream 72) to the REC 32 (step 1212).

In other words, the CPRI multiplexer 50 is generally configured to disaggregate or otherwise transform the first high speed CPRI downlink data stream (e.g. downlink stream 62) into the plurality of second CPRI downlink data streams (e.g. downlink streams 64), and to aggregate or otherwise transform the plurality of second CPRI uplink data streams (e.g. uplink streams 74) into the single first CPRI uplink data stream (e.g. uplink stream 72). By doing so, the CPRI multiplexer 50 provides the ability to multiply the number of REs 34 that can be connected to a REC 32 without modifying the REC 32. Hence, if, for example, the CPRI multiplexer 50 is a 1:4 CPRI multiplexer 50, a single CPRI port of the REC 32 can interconnect with four REs 34. Such an example in schematically shown in FIG. 11. Notably, without the CPRI multiplexer 50, a single CPRI port of a REC 32 can directly interconnect to a single RE 34.

As the CPRI multiplexer 50 is located between a REC 32 and a plurality of REs 34, the CPRI multiplexer 50 is configured to transform the single CPRI data stream received from the REC 32 into the plurality of second CPRI data streams to be transmitted to the REs 34, and vice versa. However, as the single CPRI data stream received from the REC 32 comprises data addressed to different REs 34, the CPRI multiplexer 50 generally needs to perform certain tasks.

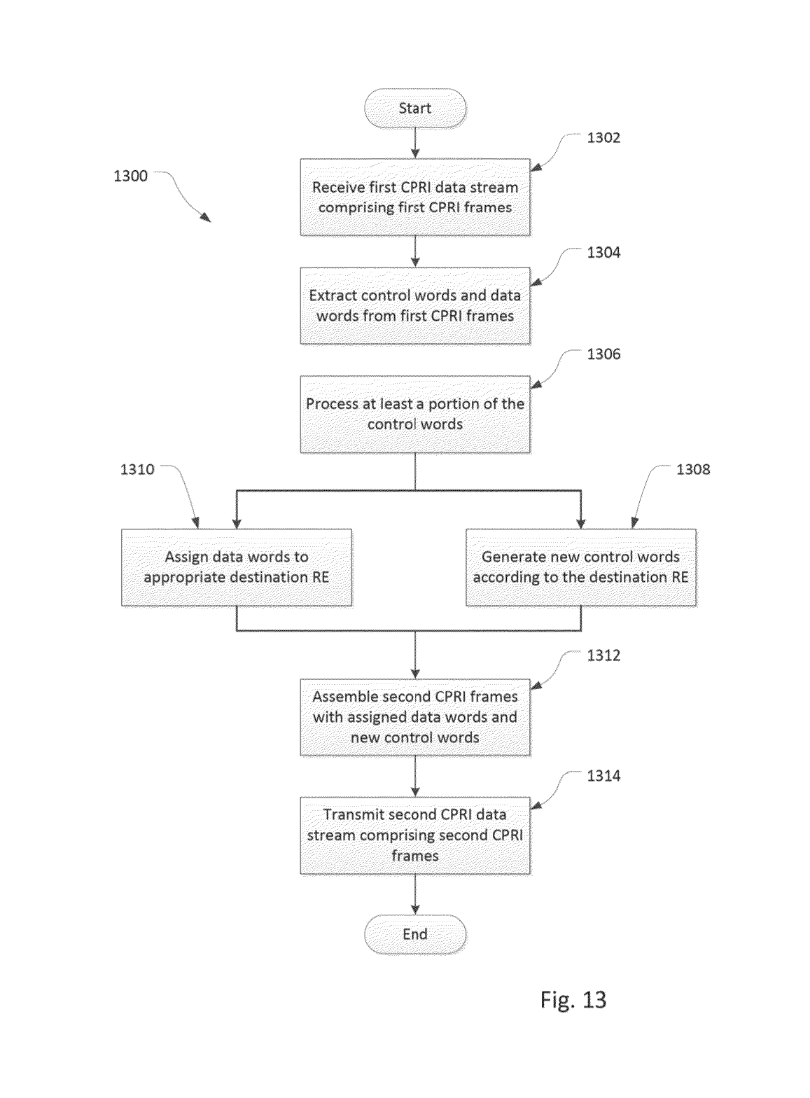

In that sense, another embodiment of a method in accordance with the present invention as implemented by the CPRI multiplexer 50 can be further illustrated by the flow chart 1300 depicted in FIG. 13.

The method 1300 generally starts by the CPRI multiplexer 50 receiving a first downlink CPRI data stream comprising first downlink CPRI frames (step 1302). Next, the CPRI multiplexer 50 extracts the control words and the data words (e.g. IQ data) from the hyperframes comprised in the first downlink CPRI data stream (step 1304). Upon having extracted the control words and data words, the CPRI multiplexer 50 processes at least some of the control words (step 1306). As indicated above with reference to FIGS. 8 to 10, the control words comprised in a hyperframe serve many purposes. Some control words relate to synchronization, some control words relate slow and fast control and management, some control words are even vendor specific. Still, some of the control words, e.g. the Ctrl_AxC control words, are directly related to the data words as the data words comprised AxC related information. Hence, the CPRI multiplexer 50 processes at least the Ctrl_AxC control words as the information contained in the Ctrl_AxC control words will be used to switch the data words to the appropriate second downlink CPRI data streams. In that sense, once the CPRI multiplexer 50 has processed the appropriate control words (step 1306), the CPRI multiplexer 50 performs two steps more or less in parallel.

First, the CPRI multiplexer 50 generates new control words for each of the plurality of second CPRI data streams (step 1308). In that sense, as control and management information to be sent to each of the REs 34 will generally differ, the new control words generated for a particular second CPRI data stream will be generated as a function of the control words extracted from the first CPRI data stream and as a function of the RE 34 to which the second CPRI data stream will be transmitted.

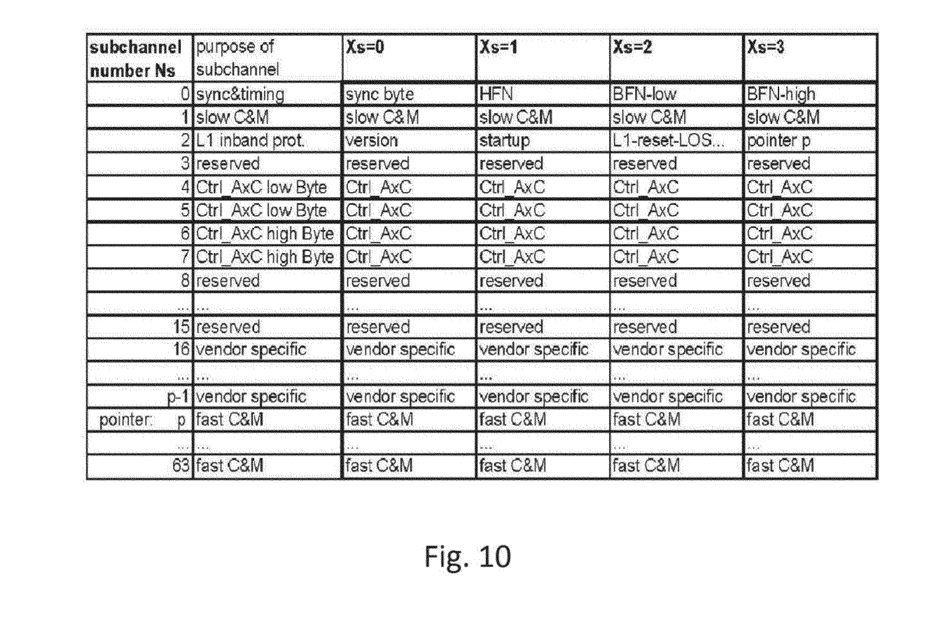

Second, the CPRI multiplexer 50 switches or otherwise routes the data words (i.e. the IQ data) previously extracted from the CPRI frames of the first CPRI data stream to the appropriate second CPRI data stream such that the data words addressed to a particular RE 34 are put in the second CPRI data stream that will be transmitted to that particular RE 34 (step 1310). To perform this task, the CPRI multiplexer 50 uses the control information contained in some of the control words, particularly in the Ctrl_AxC control words (see FIG. 10).

Once the new control words are generated and the data words are properly switched, the CPRI multiplexer 50 assembles hyperframes and then CPRI frames with the new control words and the switched data words (step 1312). Finally, the CPRI multiplexer 50 transmits the second CPRI data streams, each comprising assembled CPRI frames, to their respective REs 34 (step 1314).

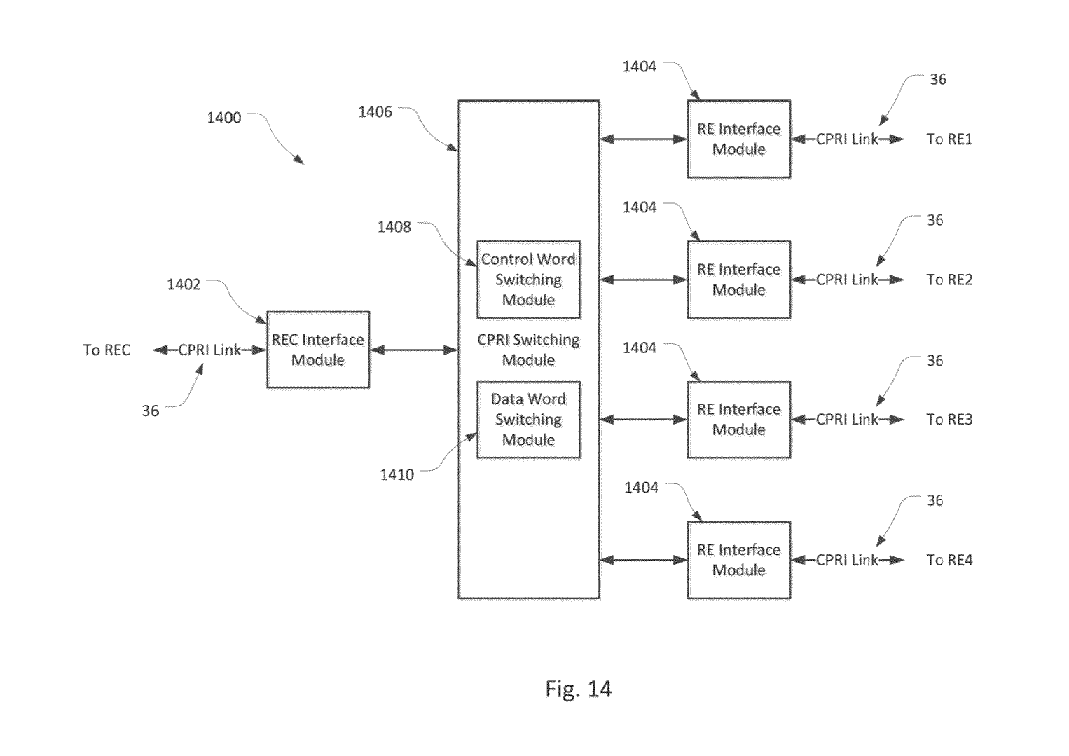

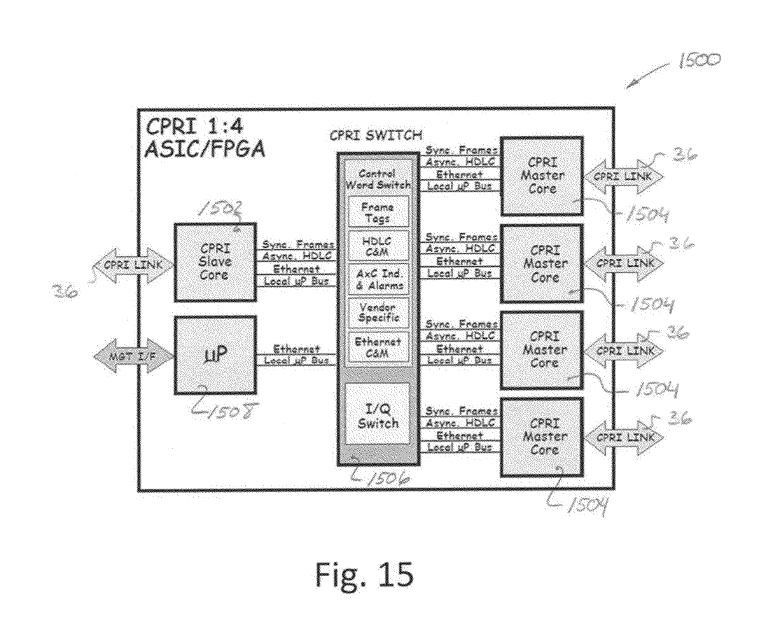

Referring now to FIGS. 14 and 15, methods to multiplex and demultiplex CPRI data streams, such as the methods described above, may be performed by a CPRI multiplexer 50 comprising various combinations of components or modules.

Hence, referring to FIG. 14, an embodiment 1400 of a CPRI multiplexer 50 is illustrated as comprising various modules. More particularly, in FIG. 14, the CPRI multiplexer 50 generally comprises a REC interface module 1402, a plurality of RE interface modules 1404 (e.g. four are shown), and a CPRI switching module 1406.

The REC interface module 1402 is generally configured to receive the first downlink CPRI data stream (e.g. downlink stream 62 in FIG. 11) from the REC 32 and to transmit the first uplink CPRI data stream (e.g. uplink stream 72 in FIG. 11) to the REC 32.

For their part, each of the RE interface modules 1404 is generally configured to transmit one of the second downlink CPRI data streams (e.g. downlink stream 64 in FIG. 11) to one of the RE 34 and to receive one of the second uplink CPRI data streams (e.g. uplink stream 72 in FIG. 11) from that RE 34.

The CPRI switching module 1406, which is in communication with both the REC interface module 1402 and the RE interface modules 1404, is generally configured to operate the processing and switching of the control words and the switching of the data words. In that sense, in the present embodiment, the CPRI switching module 1406 comprises a control word switching module 1408 for processing and switching of the control words and a data word switching module 1410 for switching of the data words.

The various modules 1402, 1404 and 1406 can be implemented as circuitry which may comprise a microprocessor and a memory storing instructions to perform the necessary processing.

Referring now to FIG. 15, another embodiment 1500 of a CPRI multiplexer 50 is illustrated as comprising various components. More particularly, in FIG. 15, the CPRI multiplexer 50 generally comprises a CPRI slave core 1502, a plurality of CPRI master cores 1504 (e.g. four are shown), a CPRI switch 1506, and a micro-processor 1508.

The CPRI switch 1506 is in communication with both the CPRI slave core 1502 and the CPRI master cores 1504. The CPRI switch 1506 is also in communication with the micro-processor 1508.

In the present embodiment, the CPRI slave and master cores 1502 and 1504 are configured to perform the extraction and insertion of asynchronous data streams from and to synchronous CPRI frames. The synchronous parts of a CPRI frame are composed of IQ data samples, the sync byte, the identification, and the AxC control words (see FIGS. 8 to 10). The asynchronous portions of the CPRI frame include the slow control and management (C&M), the fast C&M, and the vendor specific channels which are transmitted as HDLC or Ethernet messaging (see FIGS. 8 to 10).

Once the synchronous and asynchronous parts are extracted from a CPRI frame, they are forwarded to the CPRI switch 1506 which is configured to cross-connect the various data flows between the CPRI slave core 1502 and the plurality of CPRI master cores 1504. In the present embodiment, the CPRI switch 1506 generally performs two kinds of routing or switching: control word switching and payload switching.

The control word switching function can be simplified into: frame tag, HDLC C&M, AxC Indicators & Alarms, Vendor Specific, and Ethernet C&M flows.

The payload switching function transports IQ data and filler information.

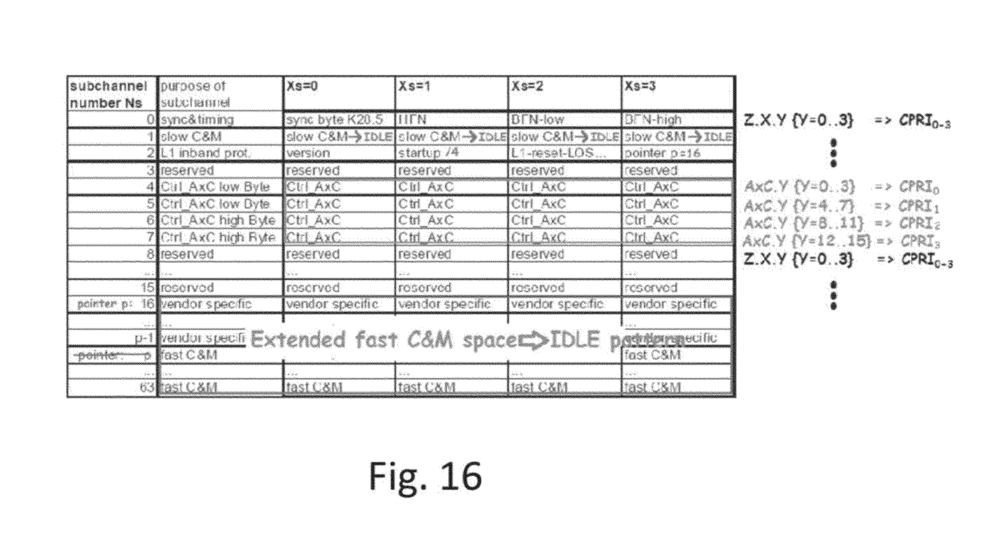

An exemplary embodiment of the processing and switching of the control words in accordance with the principles of the present invention is illustrated in FIG. 16.

The processing and switching of the following synchronous control words (regardless of link speed): sync, hyperframe number (HFN), CPRI frame number low (BFN-low), CPRI frame number high (BFN-high), version, start-up, reset, and pointer p, can be accomplished by copying the data to the “sync frame” interfaces of the destination CPRI cores 1502/1504.

The processing and switching of asynchronous slow C&M channel control words is performed by extracting the HDLC messages within the CPRI cores 1502/1504. The CPRI switch 1506 then erases or otherwise overwrites the HLDC content by writing idle (e.g. “01111110”) flag patterns to the sync frame interfaces of the destination CPRI cores 1502/1504. Subsequently, when a complete HLDC message is received by a CPRI core 1502/1504, the micro-processor 1508 is interrupted, which in turn fetches and deciphers the HDLC message, which is then forwarded to the appropriate CPRI core 1502/1504 via the micro-processor 1508 bus interface, and further processed by the recipient CPRI core 1502/1504 for transmission onto a CPRI link.

The processing and switching of asynchronous fast C&M channel control words is performed by extracting Ethernet messages within the CPRI cores 1502/1504. The CPRI switch 1506 then erases or otherwise overwrites the Ethernet content by writing idle patterns to the sync frame interfaces of the destination CPRI cores 1502/1504. Subsequently, when a complete or partial (pass-thru mode) Ethernet frame is received by a CPRI core 1502/1504, the Ethernet packet is transmitted to an L2 Ethernet switch which forwards the packet to the appropriate recipient CPRI core 1502/1504, which in turn is sent on a CPRI link.

Vendor specific information can assume the form either an HLDC or Ethernet message, and can therefore be processed and switched by the HLDC or Ethernet switching methodologies already described.

Notably, in some embodiments, such as the one illustrated in FIG. 16, the vendor specific control words can be used as fast C&M channel control words to provide higher speed fast C&M channel.

The micro-processor 1508, which intercepts control plane information, configures the CPRI IQ switch function of the CPRI switch 1506 with the appropriate multiplexing and demultiplexing patterns for the data words (e.g. IQ data).

In order to interface CPRI links 36 with different line bit rates, and thus in order to adapt the numbers of AxC containers in each link, an AxC switching mechanism is implemented in the CPRI multiplexer 50. For example, assuming that the first CPRI link uses the line bit rate 9830.4 Mbps, the number of AxC containers in each the first CPRI link hyperframe is 128. When converting, for instance, into four parallel and equal second CPRI links having a line bit rate 2457.6 Mbps, as shown in FIG. 11, it is necessary for the CPRI multiplexer 50 to disaggregate the AxCs from the high speed first downlink CPRI data stream and re-aggregate the AxCs into the lower speed second downlink CPRI data streams. In addition, the CPRI multiplexer 50 also sets new or modified control words for synchronization, hyperframe numbers, CPRI frame numbers, etc. in the lower speed second CPRI data streams.

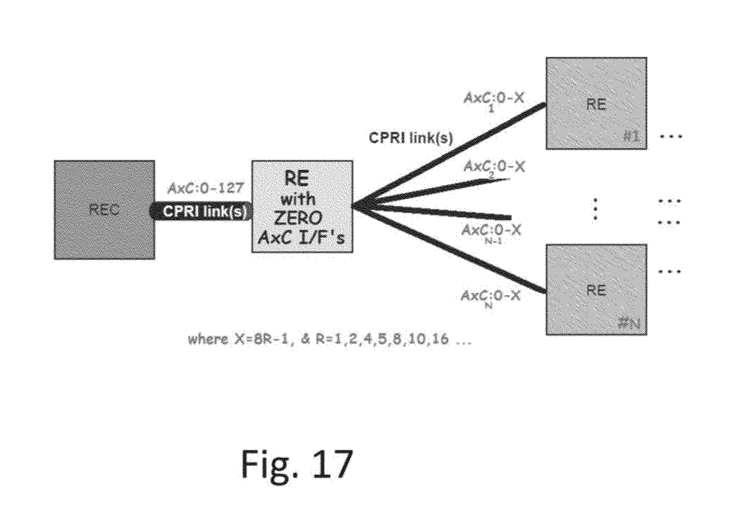

An exemplary embodiment of the switching of the data words in accordance with the principles of the present invention is illustrated in FIG. 17. In that sense, FIG. 17 illustrates an exemplary 1:4 CPRI data stream switching. Understandably, the present example can be generalized for a 1:N CPRI multiplexer 50 and/or for different line bit rate conversions.

The AxC control words allocate 2-byte positions to a specific AxCₙ where n identifies 0-127 unique antenna carriers. In other words, only 16 bits of control information can be sent to/from a specific AxC, per hyperframe (regardless of link speed). If a high-speed CPRI link is demultiplexed into slower link speeds, the range of the “X” index for the second downlinks is calculated as shown in FIG. 17.

In each REᵢ, iε{1, 2, . . . N}, the number of demultiplexed AxCs should be 8R, where 8 is the number AxC and Ctrl-AxC in base CPRI line bit rate 614.4 Mbps and Rε{1, 2, 4, 5, 8, 10, 16}, corresponding to a multiple of the CPRI base line bit rate, i.e., 614.4 Mbps, 1228.8 Mbps, 2457.6 Mbps, 3072.0 Mbps, 4915.2 Mbps, 6144.0 Mbps, 9830.4 Mbps. For example, the representation of AxC: 127 requires remapping to a base-address and low order bits index. Depending on the link speed towards RE_{N}, the possible index remapping for n=127 (B′01111111) would be: B′0bbbbxxx, B′0bbbxxxx, B′0bbxxxxx, or B′0bxxxxxx where “0bbb . . . 00” with trailing zeroes are possible base-addresses while “000 . . . xxx” with leading zeroes is representative of the adjusted REᵢindex. Lastly, the switching function of the synchronous AxCₙ control words requires maintaining the base-address in the “root-RE”, and then performing a copy of the data to the “sync frame” interfaces of the destination CPRI cores 1502/1504.

In the embodiment shown in FIG. 11, the line bit rate of the second CPRI data streams 64/74 was equal for all the second CPRI data streams 64/74 and was lower than the line bit rate of the first CPRI data streams 62/72. However, in other embodiments, the line bit rate of each of the second CPRI data streams 64/74 could not only be different, but also not necessarily lower than the line bit rate of the first CPRI data streams 62/72.

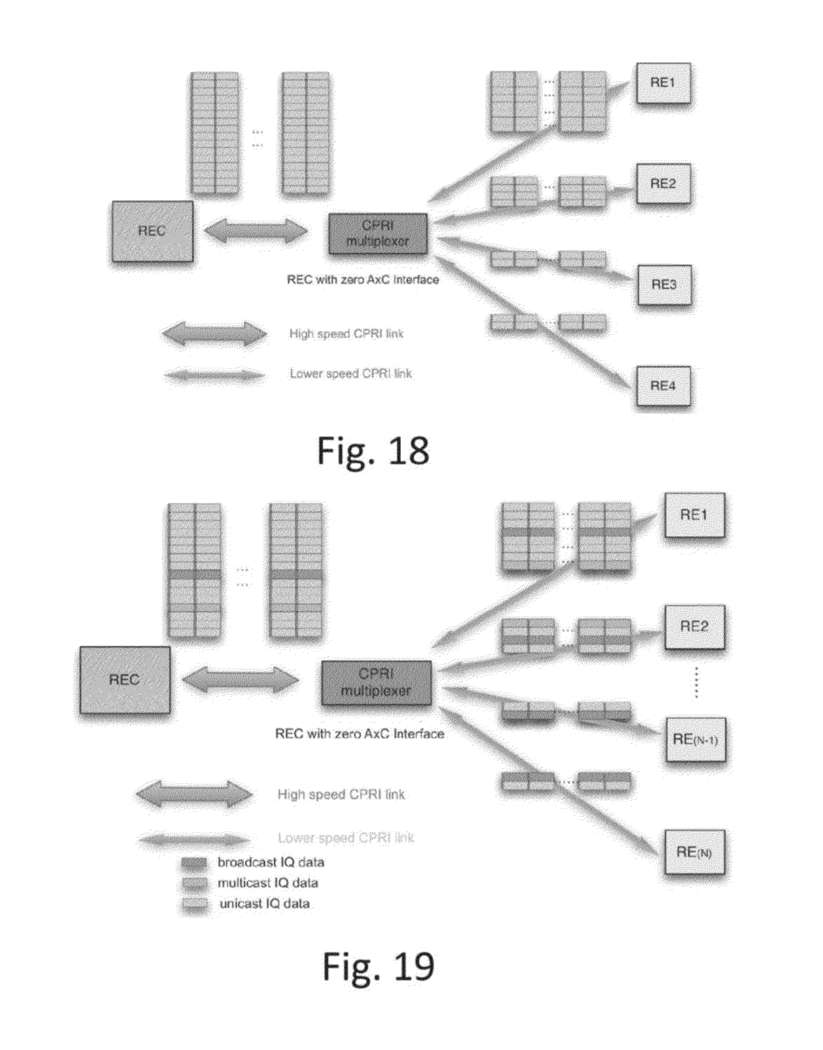

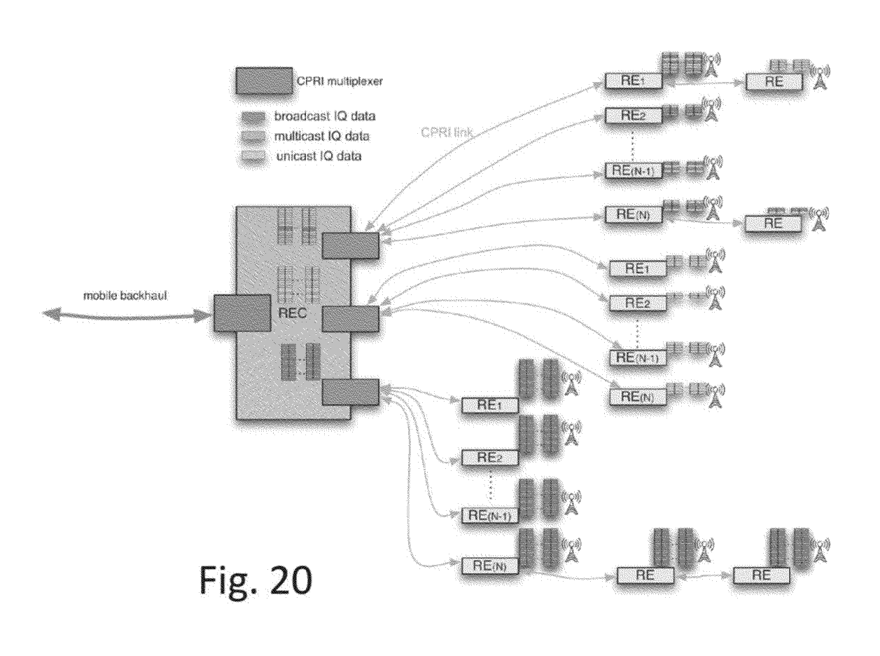

In that sense, in another embodiment in accordance with the present invention, the CPRI multiplexer 50 could additional or alternatively be configured to dynamically redistribute CPRI links with different bit rates. FIG. 18 illustrates such an embodiment in which the CPRI multiplexer 50 is capable of dynamically reconfiguring the allocated bandwidth to each second CPRI link 36. Such capabilities could be useful, for instance, in the event a certain RE unit fails. In such case, the CPRI data stream previously transmitted to the now unavailable RE could be switched to a second RE 34. If the second RE 34 is already in operation, then its line bit rate could be adjusted to accommodate for both its initial traffic and the additional traffic (i.e. the traffic of the now unavailable RE). The connection could thus be maintained and the data flow not interrupted.

In yet another embodiment in accordance with the present invention, by virtue of the multiplexing, demultiplexing and switching capabilities, the CPRI multiplexer 50 can enable unicast, broadcast and multicast transmissions for different services.

FIG. 24 illustrates a scenario in which the data words comprise unicast data words, multicast data words and broadcast data words. With the CPRI multiplexer 50, it is possible to arbitrarily distribute the ingress AxC from REC 32 to any RE 34, not necessarily in a sequential fashion. This enables broadcast or multicast implementation by replicating AxC(s) on different REs 34. With additional reference to FIG. 25, in this scheme, it is possible to discriminate the services by offering unicast, multicast and/or broadcast services, via for example chain, tree, or ring topology. This approach breaks the bandwidth limitation, i.e. the total bandwidth (i.e. the total combined line bit rate) of the demultiplexed second CPRI data streams is higher than the bandwidth (i.e. line bit rate) of the first CPRI data stream. The typical use cases can be multimedia broadcast service such as TV broadcast on LTE network (e.g. evolved Multimedia Broadcast Multicast Service, Single-Frequency Network, eMBMS SFN). In such a typical use case, the CPRI multiplexer 50 would simply replicate the broadcast data words on each of the second CPRI data streams. In such embodiments, the broadcast data words would typically be forwarded only in the downlink direction. Downlink and uplink CPRI data streams with asymmetrical bandwidth are therefore possible.

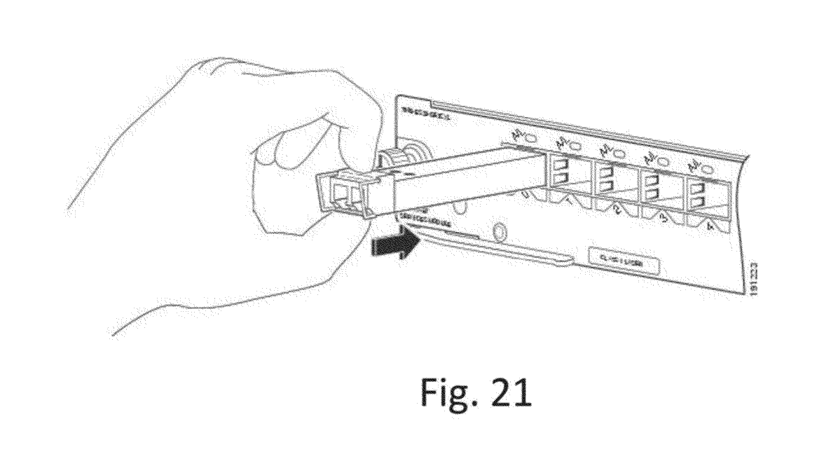

Referring to FIG. 21, in accordance with another embodiment of the present invention, the CPRI multiplexer 50 can be implemented as a general purpose pluggable module or device. In such embodiments, the CPRI multiplexer 50 is typically implemented using the SFP or SFP+ form factor. Still, in other embodiments, other standard or proprietary form factors (e.g. QSFP, XFP, and CFP) and/or standard alone equipment (e.g. line-card) implementations, in compliance with system specification and requirement, are also contemplated.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1) A multiplexer/demultiplexer device configured to multiplex and demultiplex common public radio interface (CPRI) data streams exchanged between a radio equipment controller (REC) and a plurality of radio equipment (REs), the device comprising:
a REC interface configured to receive a first downlink CPRI data stream from the REC and to transmit a first uplink CPRI data stream to the REC;
a plurality of RE interfaces configured to each transmit a respective one of a plurality of second downlink CPRI data streams to a respective one of the plurality of REs and to each receive a respective one of a plurality of second uplink CPRI data streams from a respective one of the plurality of REs;
circuitry operatively connected to the REC interface and to the RE interfaces, the circuitry being configured to:
demultiplex the first downlink CPRI data stream received from the REC;
generate the plurality of second downlink CPRI data streams from the demultiplexed first downlink CPRI data stream;
multiplex the plurality of second uplink CPRI data streams received from the plurality of REs;
generate the first uplink CPRI data stream from the multiplexed plurality of second uplink CPRI data streams.

2) A multiplexer/demultiplexer device as claimed in claim 1, wherein the CPRI data streams comprise control words and data words.

3) A multiplexer/demultiplexer device as claimed in claim 2, wherein the first downlink CPRI data stream comprises first downlink control words and first downlink data words, and wherein the circuitry is configured to, for each of the plurality of second downlink CPRI data streams, generate second downlink control words as a function of the first control words and as a function of the respective RE to which the second downlink CPRI data stream will be transmitted, and switch the portion of the first downlink data words which are addressed to the respective RE.

4) A multiplexer/demultiplexer device as claimed in claim 2, wherein each of the plurality of the second uplink CPRI data streams comprises second uplink control words and second uplink data words, and wherein the circuitry is configured to generate first uplink control words as a function of the second uplink control words of each of the plurality of the second uplink CPRI data streams, and to assemble the second uplink data words of each of the plurality of the second uplink CPRI data streams into first uplink data words.

5) A multiplexer/demultiplexer device as claimed in claim 1, wherein the first downlink CPRI data stream has a first bit rate, and wherein each of the plurality of second downlink CPRI data streams has a second bit rate, wherein each of the second bit rates is equal to or smaller than the first bit rate.

6) A multiplexer/demultiplexer device as claimed in claim 5, wherein all the second bit rates are equal.

7) A multiplexer/demultiplexer device as claimed in claim 5, wherein at least two of the second bit rates are different from each other.

8) A multiplexer/demultiplexer device as claimed in claim 2, wherein the first downlink CPRI data stream comprises first downlink data words.

9) A multiplexer/demultiplexer device as claimed in claim 8, wherein the first downlink data words comprise unicast data words, or multicast data words, or broadcast data words, or a combination thereof.

10) A multiplexer/demultiplexer device as claimed in claim 8, wherein the first downlink data words comprise multicast data words, and wherein the circuitry is configured to replicate the multicast data words in at least two of the plurality of second downlink CPRI data streams.

11) A multiplexer/demultiplexer device as claimed in claim 8, wherein the first downlink data words comprise broadcast data words, and wherein the circuitry is configured to replicate the broadcast data words in all of the plurality of second downlink CPRI data streams.

12) A multiplexer/demultiplexer device as claimed in claim 2, wherein the circuitry comprises:
a control word switching module configured to generate, for each of the second downlink CPRI data streams, new control words as a function of the control words comprised in the first downlink CPRI data stream and as a function of the respective RE to which the second downlink CPRI data stream will be transmitted;
a data word switching module configured to switch the data words comprised in the first downlink CPRI data stream and addressed to a respective RE to the respective second downlink CPRI data stream which will be transmitted to the respective RE.

13) A method for multiplexing and demultiplexing common public radio interface (CPRI) data streams exchanged between a radio equipment controller (REC) and a plurality of radio equipment (REs), the method comprising:
in a downlink direction:
demultiplexing a first downlink CPRI data stream received from the REC;
generating a plurality of second downlink CPRI data streams from the demultiplexed first downlink CPRI data stream;
transmitting a respective one of a plurality of second downlink CPRI data streams to each one of the plurality of REs; and
in an uplink direction:
multiplexing a plurality of second uplink CPRI data streams received from the plurality of REs;
generating a first uplink CPRI data stream from the multiplexed plurality of second uplink CPRI data streams;
transmitting the first uplink CPRI data stream to the REC.

14) A method as claimed in claim 13, wherein the CPRI data streams comprise control words and data words.

15) A method as claimed in claim 14, wherein the first downlink CPRI data stream comprises first downlink control words and first downlink data words, and wherein the method further comprises, for each of the plurality of second downlink CPRI data streams, generating second downlink control words as a function of the first control words and as a function of the respective RE to which the second downlink CPRI data stream will be transmitted, and switching the portion of the first downlink data words which are addressed to the respective RE.

16) A method as claimed in claim 14, wherein each of the plurality of the second uplink CPRI data streams comprises second uplink control words and second uplink data words, and wherein the method further comprises generating first uplink control words as a function of the second uplink control words of each of the plurality of the second uplink CPRI data streams, and assembling the second uplink data words of each of the plurality of the second uplink CPRI data streams into first uplink data words.

17) A method as claimed in claim 13, wherein the first downlink CPRI data stream has a first bit rate, and wherein each of the plurality of second downlink CPRI data streams has a second bit rate, wherein each of the second bit rates is equal to or smaller than the first bit rate.

18) A method as claimed in claim 17, wherein all the second bit rates are equal.

19) A method as claimed in claim 17, wherein at least two of the second bit rates are different from each other.

20) A method as claimed in claim 14, wherein the first downlink CPRI data stream comprises first downlink data words.

21) A method as claimed in claim 20, wherein the first downlink data words comprise unicast data words, or multicast data words, or broadcast data words, or a combination thereof.

22) A method as claimed in claim 21, wherein the first downlink data words comprise multicast data words, and wherein the method further comprises replicating the multicast data words in at least two of the plurality of second downlink CPRI data streams.

23) A method as claimed in claim 21, wherein the first downlink data words comprise broadcast data words, and wherein the method further comprises replicating the broadcast data words in all of the plurality of second downlink CPRI data streams.
